(19) United States
(12) Patent Application Publication
(10) Pub. No.: US 2011/0056524 A1
(43) Pub. Date: Mar. 10, 2011

(54) CLEANING AND SANITIZING APPARATUS AND METHOD

(76) Inventors: Pierantonio Milanese, Susegana (IT); Andrea Milanese, Conegilano (IT)

(21) Appl. No.: 12/565,243

(22) Filed: Sep. 23, 2009

Related U.S. Application Data
(60) Provisional application No. 61/239,843, filed on Sep. 4, 2009.

(51) Int. Cl. B08B 3/02

(52) U.S. Cl. 134/37; 134/105

(57) ABSTRACT

In the exemplary embodiment, a steam-cleaning apparatus is described for sanitizing and cleaning a surface or object. The apparatus has a first reservoir for receiving water, a heater for heating the water within the first reservoir, a second reservoir for receiving a sanitizing agent, a mixing nozzle, a first actuator for enabling the heated water from the first reservoir through the mixing nozzle at the surface or object for cleaning the surface or object; and a second actuator for enabling the sanitizing agent from the second reservoir to the mixing nozzle for mixing the sanitizing agent with the heated water therein, and for enabling the mixed heated water and sanitizing agent at the surface or object for sanitizing the surface or object deeply into its finest fissures and pores.

### RELATED APPLICATION

This application is a Continuation of and claims the benefit of pending U.S. Provisional Application Ser. No. 61/239,843, filed Sep. 4, 2009, the entire teachings of which are incorporated herein by reference.

### FIELD OF THE INVENTION

The present invention is related to steam-cleaning and disinfecting. More specifically, the invention is related to the combination of a sanitizing agent and super-heated water by a steaming apparatus to enhance the sanitizing properties of the vapor dispensed there-from, and to a steaming apparatus adapted therefore.

### BACKGROUND

Steam-cleaning appliances and steam sanitizing methods of an infinite variety are well known and commonly used for cleaning and attempting to sanitize surfaces and objects. Such apparatuses universally claim to sanitize and disinfect solely by directing super-heated water, also known as steam, at the object to be sanitized. A disadvantage common to such prior art is a failure to fully sanitize. It is found that such sanitizing efforts do not effectively penetrate the surface or object and are insufficient and typically leave living microbes within pore and fissures on the surfaces and objects, which soon regenerate. It is found the steaming of the surface or object alone oftentimes merely improves the conditions for such regeneration, eventually resulting in the surface or object being less sanitary than had it never been exposed to the steaming in the first place.

There exists a need for improvement in the sanitizing of surfaces and objects, and such is an object of the present invention. There exists the need for improvement of steaming and steam-cleaning apparatuses, and such is an object of the present invention. There exists the need for elimination of the improvement of microbial regeneration conditions on surfaces and objects after steaming, and such as an object of the present invention. There exists the need for causing the sanitizing agent to penetrate deeply into the pores and fissures of surfaces and objects, and such as an object of the present invention. Further needs and objects exist, which are addressed by the present invention, as may become apparent by the included disclosure of an exemplary embodiment thereof.

### SUMMARY OF THE INVENTION

The invention lies in a method and/or apparatus for combining steaming of a surface or object with the application of a sanitizing agent thereon, to infuse the sanitizing agent into the penetrating steam and more completely sanitize the surface or object and to discourage the subsequent regeneration of microbial life.

In one exemplary embodiment, the invention may be practiced in a method of sanitizing and cleaning a surface or object using a steam-cleaning apparatus of the type having first and second reservoirs. The method may include the steps of receiving water into the first reservoir, receiving a sanitizing agent into the second reservoir, heating the water within the first reservoir, cleaning the surface or object by directing the heated water there-at, combining the sanitizing agent with the heated water, and sanitizing the surface or object by directing the combined heated water and sanitizing agent there-at.

The step of heating the water may include heating the water to at least approximately one hundred and eighty degrees F. The step of combining the sanitizing agent and the heated water may include mixing at a volume rate of four parts sanitizing agent to ten parts water.

The sanitizing agent may include Alkyl Dimethyl Ethylbenzyl Ammonium Chloride, BTC 2125 and Chlorine Dioxide. The percentage by volume in the sanitizing agent of the Alkyl Dimethyl Ethylbenzyl Ammonium Chloride may be approximately 0.125. The percentage by volume in the sanitizing agent of the BTC 2125 may be approximately 0.125. The percentage by volume in the sanitizing agent of the Chlorine Dioxide may be approximately 0.20.

The invention may also be embodied in a method of sanitizing a surface or object using a steaming apparatus, the method including the steps of receiving water into a reservoir of the steaming apparatus, receiving the sanitizing agent into the reservoir, heating the water and sanitizing agent, and sanitizing the surface or object by directing the combined heated water and sanitizing agent there-at.

The step of heating the water and sanitizing agent may include heating to at least approximately one hundred and eighty degrees F. The water and sanitizing agent received into the reservoir may be received at a volume rate of approximately four parts sanitizing agent to ten parts water.

The invention may also be embodied in a steam-cleaning apparatus for sanitizing and cleaning a surface or object and including a first reservoir for receiving water, a heater for heating the water within the first reservoir, a second reservoir for receiving a sanitizing agent, a mixing nozzle, a first actuator for enabling the heated water from the first reservoir through the mixing nozzle at the surface or object for cleaning the surface or object, and a second actuator for enabling the sanitizing agent from the second reservoir to the mixing nozzle for mixing the sanitizing agent with the heated water therein, and for enabling the mixed heated water and sanitizing agent at the surface or object for sanitizing the surface or object. The heater may be adapted to heat the water to at least approximately one hundred and eighty degrees F. The mixing nozzle may be adapted to mix the sanitizing agent with the heated water at a volume rate of four parts sanitizing agent to ten parts water.

The invention may also be embodied in a steaming apparatus for sanitizing a surface or object and including a reservoir for receiving water and a sanitizing agent, a heater for heating the water and sanitizing agent within the reservoir, a nozzle, an actuator for enabling the heated water and sanitizing agent from the reservoir through the nozzle at the surface or object for sanitizing the surface or object. The heater may be adapted to heat the water and sanitizing agent to at least approximately one hundred and eighty degrees F.

Further features and aspects of the invention are disclosed with more specificity in the Detailed Description, Drawings, and Appendices provided herein and showing exemplary embodiments of the invention.

### BRIEF DESCRIPTION OF THE DRAWINGS AND APPENDICES

Many aspects of the invention can be better understood with reference to the included drawings and appendices. The components in the drawings are not necessarily to scale, and all components may not be present in all views, emphasis instead being placed upon clearly illustrating the principles of the present invention. Moreover, in the drawings, like reference numerals designate corresponding parts throughout the several views.

FIG. 1 is a perspective view of an exemplary steam-cleaning apparatus for use in practicing the invention;

FIG. 2 is a perspective view showing the adding of a disinfecting solution to the steaming apparatus of FIG. 1;

FIG. 3 is a perspective view of the apparatus of FIG. 1 dispensing a combination of water vapor and vaporized disinfectant;

FIGS. 4A to 4C are a series of cross-sectional views of the apparatus of FIG. 1 in various modes of operation;

FIGS. 5A to 5C show a microbiological study report on the sanitizing efficacy of the steaming apparatus of FIG. 1 using alternative sanitizing agents; and

FIGS. 6A to 6E are an instruction manual used in conjunction with the steam-cleaning apparatus of FIG. 1.

Appendix A is a webpage screenshot describing the steam-cleaning apparatus of the Figures; and

Appendix B is a webpage screenshot describing a second exemplary steam-cleaning apparatus for use in practicing the invention.

### DETAILED DESCRIPTION

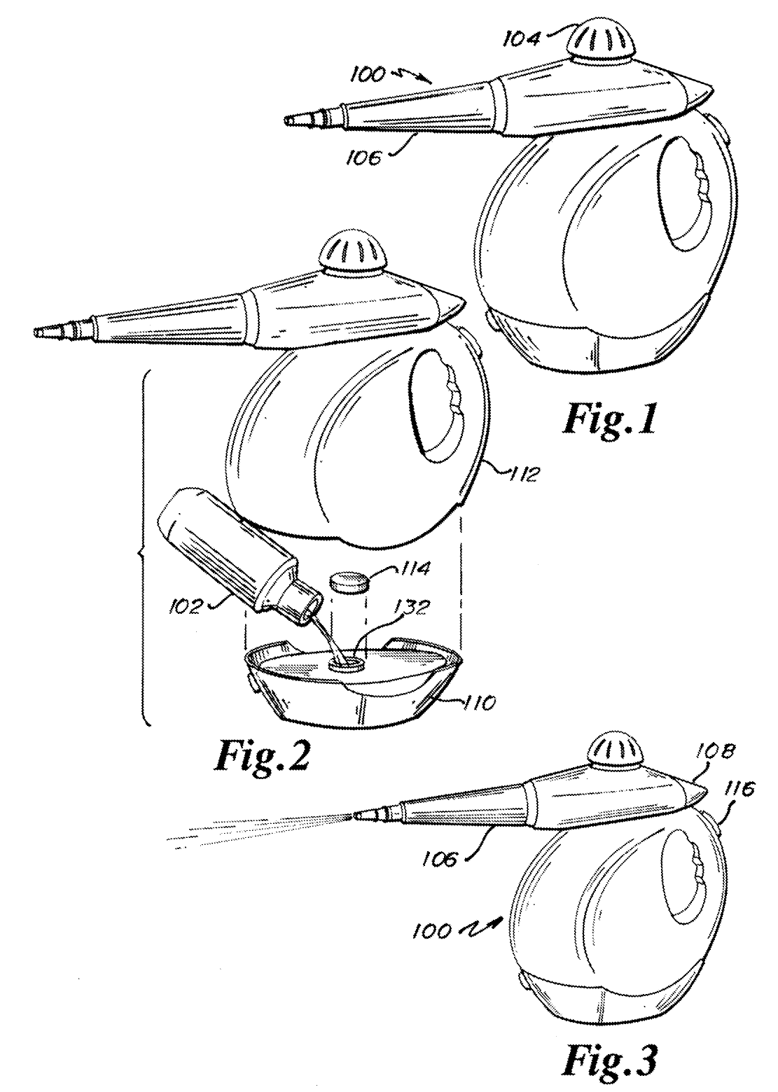

Reference is now made to FIGS. 1 through 4C, where there is shown a steam-cleaning apparatus 100 for vaporizing water and a sanitizing agent 102 according to a first exemplary one of the infinite number of possible embodiments of the present invention.

Referring first to FIG. 1, steam-cleaning apparatus 100 is merely exemplary and it should be understood that the invention may be practiced using any equivalent steam-cleaning appliance having means to accept an additive such as sanitizing agent 102 of FIG. 2 to be vaporized and dispensed with super-heated water. Such alternative steam-cleaners include those taught in US Publications 2008/0034623, 2006/0000048, 20060162396, and 20050125934, and in U.S. Pat. Nos. 7,051,462 and 6,711,840, the specifications of which are incorporated herein in there entireties by reference.

Reference is not made to FIGS. 1 through 4C. For cleaning surfaces and objects with steam, relatively pure water 124 is added into an internal boiling chamber 122 of apparatus 100 though a top opening 130 after lid 104 is temporarily removed. Lid 104 is replaced after the chamber 122 is filled, and the apparatus is energized to heat the water 124 within the chamber, which is retained therein under pressure.

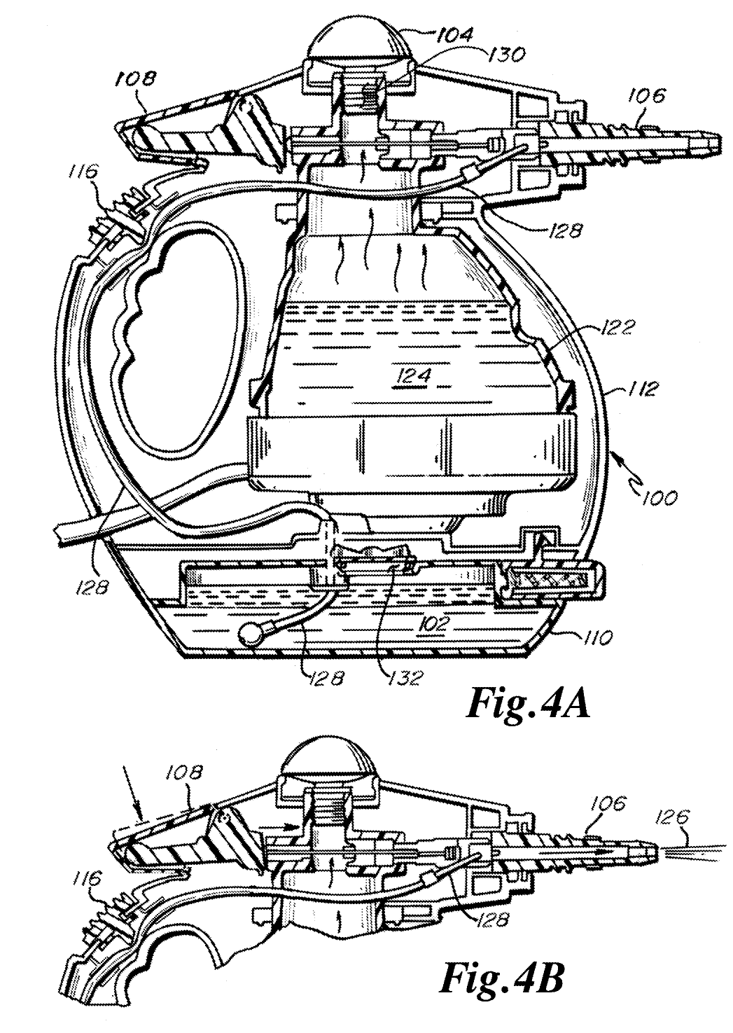

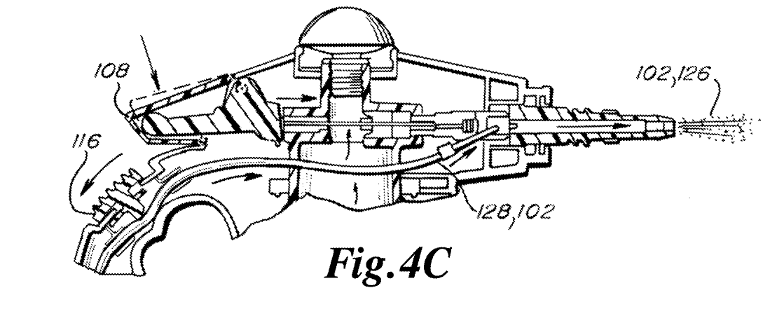

Boiling chamber 122 communicates with nozzle 106 through steam trigger 108, such that the steam trigger normally denies escape of steam from the boiling chamber, as in FIG. 4A, and activation of the steam trigger 108 as in FIGS. 4B and 4C allows the escape of steam 126 from the chamber to and through nozzle 106. Normal steam-cleaning of surfaces and objects is performed by aiming nozzle 106 at the surface or object and activating steam trigger 108 to cause a jet of pressurized steam 126 from the nozzle towards the object or surface.

Apparatus 100 also includes auxiliary reservoir 110, which may be removed from apparatus body 112 as in FIG. 2 and from which is temporarily removed cap 114. Sanitizing agent 102 is poured into reservoir 110 though reservoir opening 132, cap 114 is replaced, and reservoir 110 is reattached to body 112.

Nozzle 106 is a mixing nozzle communicating with the boiling chamber through trigger 108 as previously explained, and also with reservoir 110 though feed tube 128 via sanitizing trigger 116. As seen in FIG. 4A, steam trigger 108 denies escape of heated water from boiling chamber 122 when the trigger is not activated. As seen in FIGS. 4A and 4B, sanitizing trigger 116 normally denies escape of sanitizing agent 102 from reservoir 110 by pinching feed tube 128, and activation of the sanitizing trigger releases the resilient feed tube to allow the escape of agent 102 through the tube from the reservoir 110 to nozzle 106.

The rapid escape of steam through nozzle 106 during steaming and when sanitizing trigger 116 is released as in FIG. 4C causes a Venturi Effect within nozzle 106 which sucks agent 102 into the nozzle through tube 120 from reservoir 110 and mixes it into the steam spray 126. Sanitizing of surfaces and objects is performed by aiming nozzle 106 at the surface or object and simultaneously activating steam trigger 108 and sanitizing trigger 116 to cause a jet of pressurized steam from the nozzle towards an object or surface, as shown in FIG. 3.

The nozzle's conduit size and the feed tube are relatively sized to cause a mixing of the steam and sanitizing agent in the nozzle at a volume rate of four parts sanitizing agent to ten parts water.

The penetrating of the super-heated steam into the surface or object is found to infuse the surface or object with sanitizing agent far deeper and into far finer pores and fissures that would be realized through application of the sanitizing agent alone. And while the afore-described application of sanitizing agent is advantageous for infusing virtually any sanitizing agent, the preferred sanitizing agent 102 is found to be a liquid consisting of Active Ingredients in an inert base. The inert base is preferably water, but could also be an alcohol or a surfactant. The Active Ingredients preferably include:

0.125% Alkyl*dimethyl ethylbenzyl ammonium chloride*(68% C12, 32% C14);

0.125% BTC 2125, component of (with 069111); and

0.2% Chlorine dioxide.

Synonyms for and/or equivalents to Alkyl*dimethyl ethylbenzyl ammonium chloride*(68% C12, 32% C14) include:

BTC 2125M, component of (with 069104);

BX-673;

C12-14-alkyl(ethylbenzyl)dimethyl ammonium chlorides; and

Quaternary ammonium compounds, C12-14-alkyl((ethylphenyl)methyl)dimethyl, chlorides.

Synonyms for BTC 2125, component of (with 069111) include:

Alkyl*dimethyl benzyl ammonium chloride*(60% C14, 30% C16, 5% C18, 5% C12);

BTC 2125M (Use 2 code nos. 069104 and 069154);

BTC 776; and

BTC824.

Synonyms for and/or equivalents to Chlorine Dioxide include:

Chlorine Oxide; and

Chlorine Peroxide.

Through testing, it is found that the steam cleaning procedure described above and using the described mixture of steam and sanitizing agent kills 99.99% of at least Animal Pathogenic Bacteria (g− And G+Vegetative), Aspergillus Niger, Mold, Mildew, Salmonella Enterica, Staphylococcus Aureus, E. Coli, Legionella Pneumophila, and Norovirus. Because killing via the preferred agent is achieved by oxidation, it does not mask, but instead eliminates odors caused by such organisms. Other organic odors caused by such sources as fire and smoke are also eliminated. Through a combination of sterilization and sanitizing residue, microbial growth and odors are eliminated for extended periods over other forms of cleaning, in most cases up to seven days.

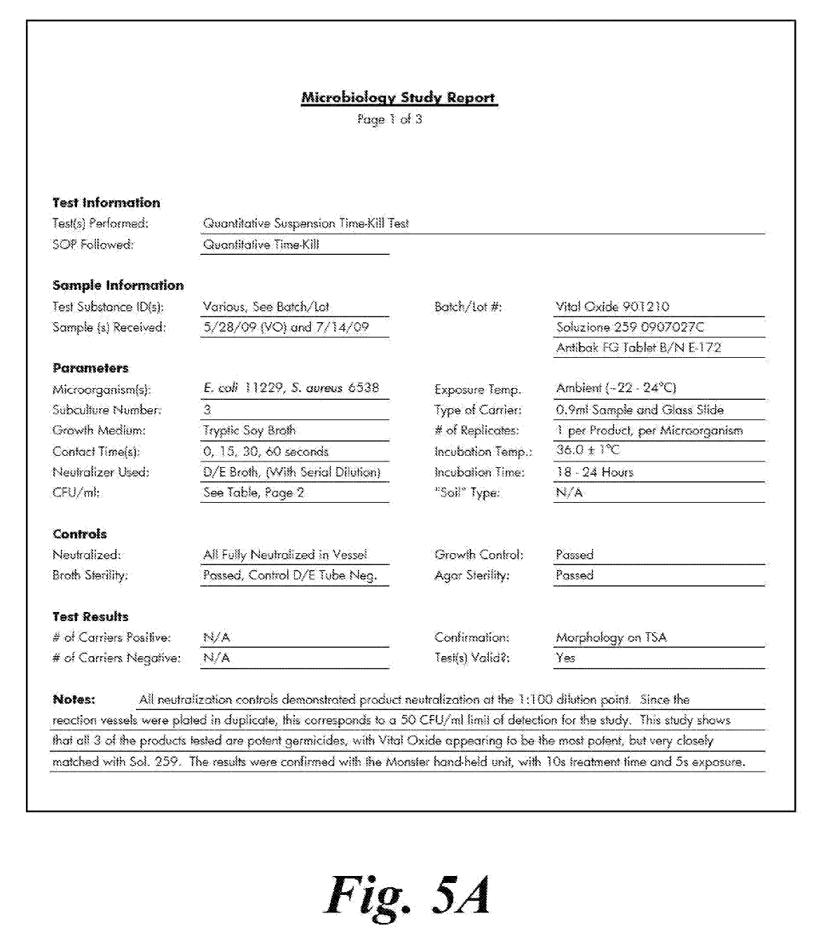

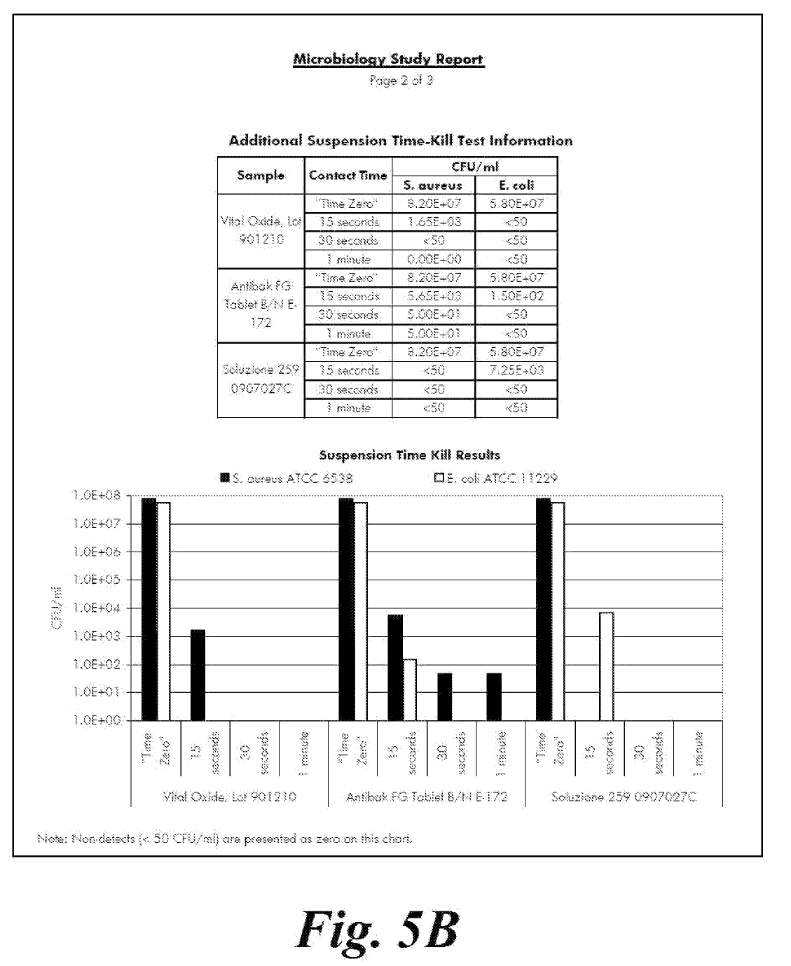

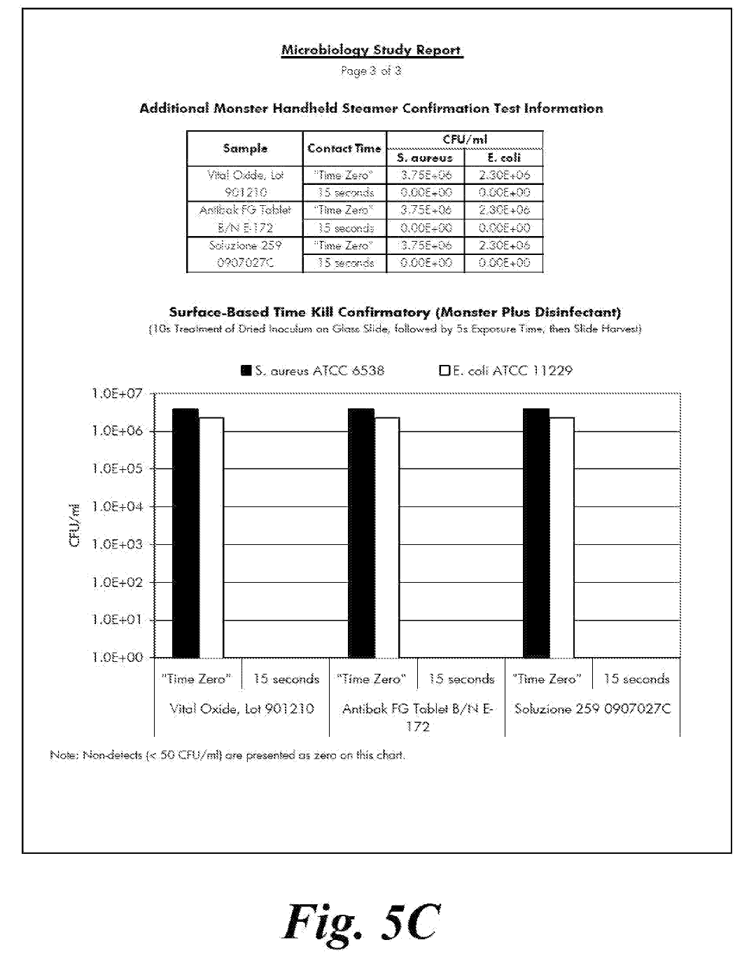

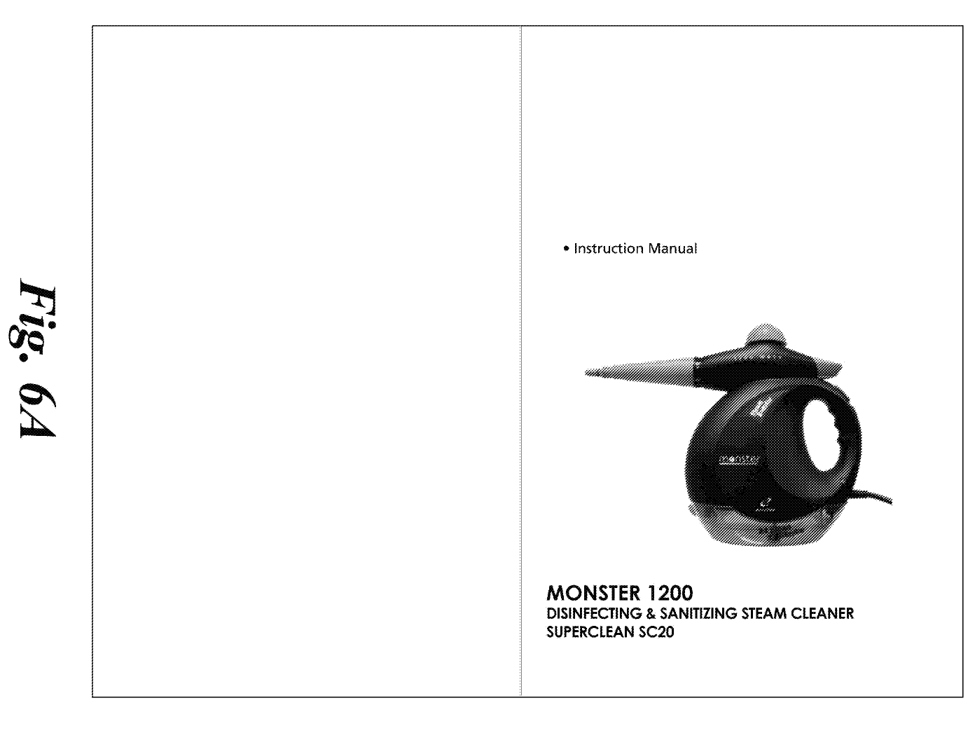

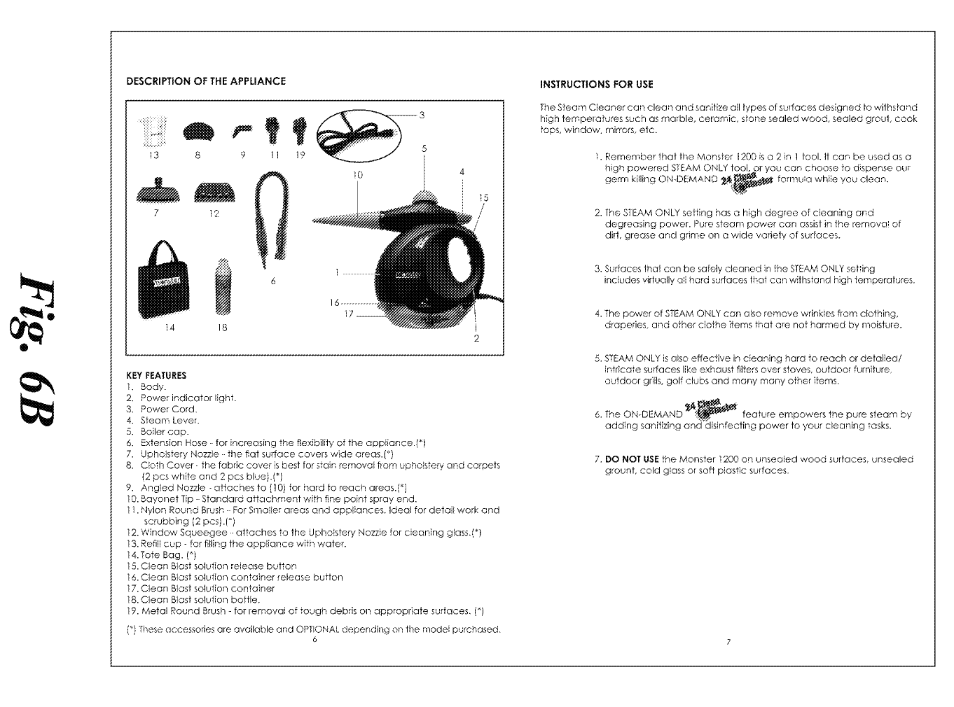

FIGS. 5A to 5C show a microbiology study report in which apparatus 100 was used as described with three alternative oxidizing agents;

Vital Oxide, (Chlorine dioxide 0.20%; Alkyl*dimethyl benzyl ammonium chloride*(60% C14, 30% C16, 5% C12, 5% C18) 0.125%, and Alkyl*dimethyl ethylbenzyl ammonium chloride*(68% C12, 32% C14) 0.125%);

Antibak FG (Potassium peroxymonosulphate 30-50%; Sodium dodecylbenzene sulphonate 0-5%; and Tetrasodium ethylene diamine tetraacetate 0-5%); and

Soluzione 259, a proprietary blend of the chemical components included above. As shown in the report, rapid and thorough sanitization is achieved.

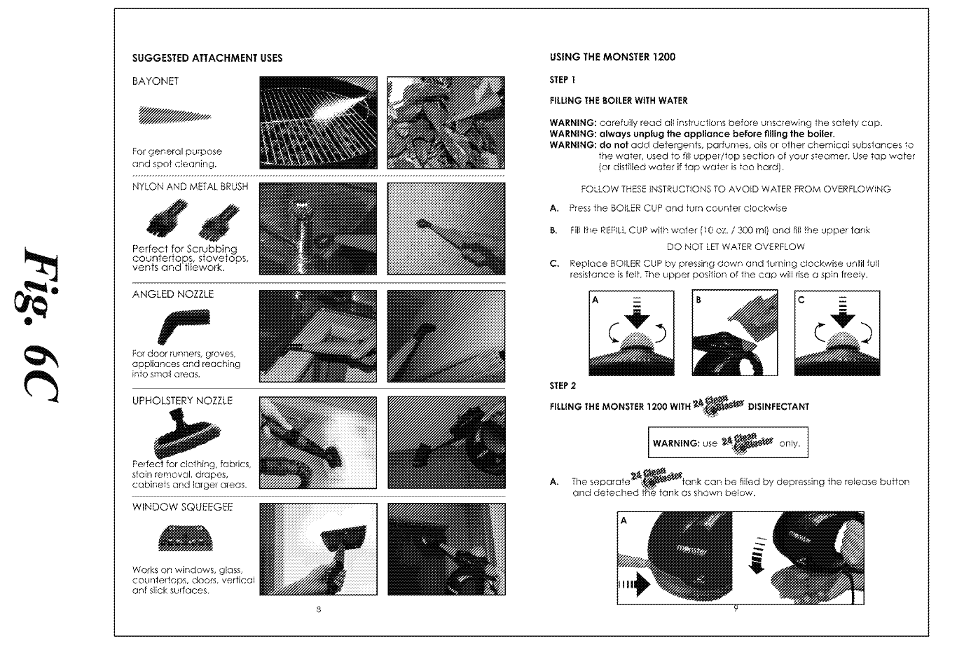

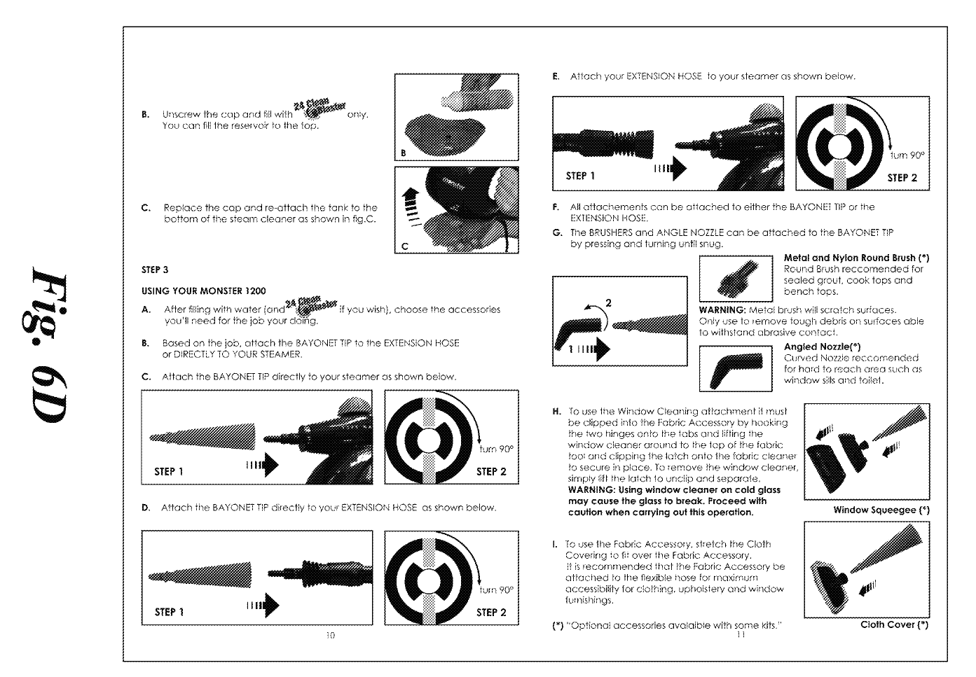

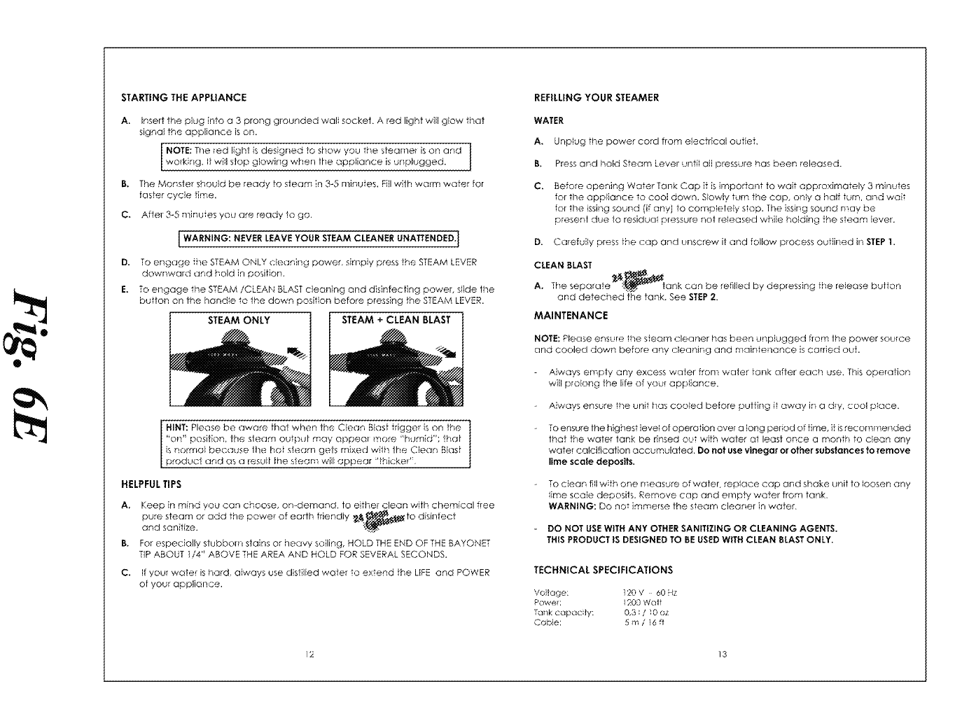

FIGS. 6A through 6E collectively are an instruction manual outlining the use of apparatus 100 with sanitizing agent 102. Appendix A is a screenshot of a webpage showing and describing various marketing and technical features of apparatus 100. Appendix B is a screenshot of a webpage showing and describing various marketing and technical features of an alternative apparatus for use in practicing the invention.

While the invention has been shown and described with reference to a specific exemplary embodiment, it should be understood by those skilled in the art that various changes in form and detail may be made without departing from the spirit and scope of the invention, and that the invention should therefore only be limited according to the following claims, including all equivalent interpretation to which they are entitled.

We claim:

1. A method of sanitizing and cleaning a surface or object using a steam-cleaning apparatus of the type having first and second reservoirs, the method comprising;
receiving water into the first reservoir;
receiving a sanitizing agent into the second reservoir;
heating the water within the first reservoir;
cleaning the surface or object by directing the heated water there-at;
combining the sanitizing agent with the heated water; and
sanitizing the surface or object by directing the combined heated water and sanitizing agent there-at.

2. The method of claim 1 wherein said step of heating the water comprises heating the water to at least approximately one hundred and eighty degrees F.

3. The method of claim 1 wherein said step of combining the sanitizing agent and the heated water comprises mixing at a volume rate of approximately four parts sanitizing agent to ten parts water.

4. The method of claim 1 wherein the sanitizing agent comprises Alkyl Dimethyl Ethylbenzyl Ammonium Chloride.

5. The method of claim 4 wherein the percentage of Alkyl Dimethyl Ethylbenzyl Ammonium Chloride by volume of the sanitizing agent is approximately 0.125.

6. The method of claim 1 wherein the sanitizing agent further comprises BTC 2125.

7. The method of claim 6 wherein the percentage of BTC 2125 by volume of the sanitizing agent is approximately 0.125.

8. The method of claim 1 wherein the sanitizing agent further comprises Chlorine Dioxide.

9. The method of claim 8 wherein the percentage of Chlorine Dioxide by volume of the sanitizing agent is approximately 0.20.

10. The method of claim 1 wherein the sanitizing solution comprises Alkyl Dimethyl Ethylbenzyl Ammonium Chloride, BTC 2125, and Chlorine Dioxide.

11. The method of claim 10 wherein the percentage of Alkyl Dimethyl Ethylbenzyl Ammonium Chloride by volume of the sanitizing agent is approximately 0.125.

12. The method of claim 11 wherein the percentage of BTC 2125 by volume of the sanitizing agent is approximately 0.125.

13. The method of claim 12 wherein the percentage of Chlorine Dioxide by volume of the sanitizing agent is approximately 0.20.

14. The method of claim 2 wherein the sanitizing solution comprises Alkyl Dimethyl Ethylbenzyl Ammonium Chloride, BTC 2125, and Chlorine Dioxide.

15. The method of claim 14 wherein the percentage of Alkyl Dimethyl Ethylbenzyl Ammonium Chloride by volume of the sanitizing agent is approximately 0.125.

16. The method of claim 15 wherein the percentage of BTC 2125 by volume of the sanitizing agent is approximately 0.125.

17. The method of claim 16 wherein the percentage of Chlorine Dioxide by volume of the sanitizing agent is approximately 0.20.

18. The method of claim 3 wherein the sanitizing solution comprises Alkyl Dimethyl Ethylbenzyl Ammonium Chloride, BTC 2125, and Chlorine Dioxide.

19. The method of claim 18 wherein the percentage of Alkyl Dimethyl Ethylbenzyl Ammonium Chloride by volume of the sanitizing agent is approximately 0.125.

20. The method of claim 19 wherein the percentage of BTC 2125 by volume of the sanitizing agent is approximately 0.125.

21. The method of claim 20 wherein the percentage of Chlorine Dioxide by volume of the sanitizing agent is approximately 0.20.

22. The method of claim 2 wherein the sanitizing agent comprises Alkyl Dimethyl Ethylbenzyl Ammonium Chloride.

23. The method of claim 22 wherein the percentage of Alkyl Dimethyl Ethylbenzyl Ammonium Chloride by volume of the sanitizing agent is approximately 0.125.

24. The method of claim 2 wherein the sanitizing agent further comprises BTC 2125.

25. The method of claim 24 wherein the percentage of BTC 2125 by volume of the sanitizing agent is approximately 0.125.

26. The method of claim 2 wherein the sanitizing agent further comprises Chlorine Dioxide.

27. The method of claim 26 wherein the percentage of Chlorine Dioxide by volume of the sanitizing agent is approximately 0.20.

28. The method of claim 3 wherein the sanitizing agent comprises Alkyl Dimethyl Ethylbenzyl Ammonium Chloride.

29. The method of claim 28 wherein the percentage of Alkyl Dimethyl Ethylbenzyl Ammonium Chloride by volume of the sanitizing agent is approximately 0.125.

30. The method of claim 3 wherein the sanitizing agent further comprises BTC 2125.

31. The method of claim 30 wherein the percentage of BTC 2125 by volume of the sanitizing agent is approximately 0.125.

32. The method of claim 3 wherein the sanitizing agent further comprises Chlorine Dioxide.

33. The method of claim 32 wherein the percentage of Chlorine Dioxide by volume of the sanitizing agent is approximately 0.20.

34. A method of sanitizing a surface or object using a steaming apparatus, the method comprising;
receiving water into a reservoir of the steaming apparatus;
receiving a sanitizing agent into the reservoir;
heating the water and sanitizing agent; and
sanitizing the surface or object by directing the combined heated water and sanitizing agent there-at.

35. The method of claim 34 wherein said step of heating the water and sanitizing agent comprises heating to at least approximately one hundred and eighty degrees F.

36. The method of claim 34 wherein the water and sanitizing agent received into the reservoir are received at a volume rate of approximately four parts sanitizing agent to ten parts water.

36. The method of claim 34 wherein the sanitizing agent comprises Alkyl Dimethyl Ethylbenzyl Ammonium Chloride.

37. The method of claim 37 wherein the percentage of Alkyl Dimethyl Ethylbenzyl Ammonium Chloride by volume of the sanitizing agent is approximately 0.125.

38. The method of claim 34 wherein the sanitizing agent further comprises BTC 2125.

39. The method of claim 38 wherein the percentage of BTC 2125 by volume of the sanitizing agent is approximately 0.125.

40. The method of claim 34 wherein the sanitizing agent further comprises Chlorine Dioxide.

41. The method of claim 40 wherein the percentage of Chlorine Dioxide by volume of the sanitizing agent is approximately 0.20.

42. The method of claim 34 wherein the sanitizing solution comprises Alkyl Dimethyl Ethylbenzyl Ammonium Chloride, BTC 2125, and Chlorine Dioxide.

43. The method of claim 42 wherein the percentage of Alkyl Dimethyl Ethylbenzyl Ammonium Chloride by volume of the sanitizing agent is approximately 0.125.

44. The method of claim 43 wherein the percentage of BTC 2125 by volume of the sanitizing agent is approximately 0.125.

45. The method of claim 44 wherein the percentage of Chlorine Dioxide by volume of the sanitizing agent is approximately 0.20.

46. The method of claim 35 wherein the sanitizing solution comprises Alkyl Dimethyl Ethylbenzyl Ammonium Chloride, BTC 2125, and Chlorine Dioxide.

47. The method of claim 46 wherein the percentage of Alkyl Dimethyl Ethylbenzyl Ammonium Chloride by volume of the sanitizing agent is approximately 0.125.

48. The method of claim 47 wherein the percentage of BTC 2125 by volume of the sanitizing agent is approximately 0.125.

49. The method of claim 48 wherein the percentage of Chlorine Dioxide by volume of the sanitizing agent is approximately 0.20.

50. The method of claim 36 wherein the sanitizing solution comprises Alkyl Dimethyl Ethylbenzyl Ammonium Chloride, BTC 2125, and Chlorine Dioxide.

51. The method of claim 50 wherein the percentage of Alkyl Dimethyl Ethylbenzyl Ammonium Chloride by volume of the sanitizing agent is approximately 0.125.

52. The method of claim 51 wherein the percentage of BTC 2125 by volume of the sanitizing agent is approximately 0.125.

53. The method of claim 52 wherein the percentage of Chlorine Dioxide by volume of the sanitizing agent is approximately 0.20.

54. The method of claim 35 wherein the sanitizing agent comprises Alkyl Dimethyl Ethylbenzyl Ammonium Chloride.

55. The method of claim 54 wherein the percentage of Alkyl Dimethyl Ethylbenzyl Ammonium Chloride by volume of the sanitizing agent is approximately 0.125.

56. The method of claim 35 wherein the sanitizing agent further comprises BTC 2125.

57. The method of claim 56 wherein the percentage of BTC 2125 by volume of the sanitizing agent is approximately 0.125.

59. The method of claim 35 wherein the sanitizing agent further comprises Chlorine Dioxide.

60. The method of claim 59 wherein the percentage of Chlorine Dioxide by volume of the sanitizing agent is approximately 0.20.

61. The method of claim 36 wherein the sanitizing agent comprises Alkyl Dimethyl Ethylbenzyl Ammonium Chloride.

62. The method of claim 61 wherein the percentage of Alkyl Dimethyl Ethylbenzyl Ammonium Chloride by volume of the sanitizing agent is approximately 0.125.

63. The method of claim 36 wherein the sanitizing agent further comprises BTC 2125.

64. The method of claim 63 wherein the percentage of BTC 2125 by volume of the sanitizing agent is approximately 0.125.

65. The method of claim 36 wherein the sanitizing agent further comprises Chlorine Dioxide.

66. The method of claim 65 wherein the percentage of Chlorine Dioxide by volume of the sanitizing agent is approximately 0.20.

67. A steam-cleaning apparatus for sanitizing and cleaning a surface or object and comprising:
a first reservoir for receiving water;
a heater for heating the water within said first reservoir;
a second reservoir for receiving a sanitizing agent;
a mixing nozzle;
a first actuator for enabling the heated water from said first reservoir through said mixing nozzle at the surface or object for cleaning the surface or object; and
a second actuator for enabling the sanitizing agent from said second reservoir to said mixing nozzle for mixing the sanitizing agent with the heated water therein, and for enabling the mixed heated water and sanitizing agent at the surface or object for sanitizing the surface or object.

68. The steam-cleaning apparatus of claim 67 wherein said heater is adapted to heat the water to at least approximately one hundred and eighty degrees F.

69. The method of claim 67 wherein said mixing nozzle is adapted to mix the sanitizing agent with the heated water at a volume rate of four parts sanitizing agent to ten parts water.

70. The steam-cleaning apparatus of claim 69 wherein said heater is adapted to heat the water to at least approximately one hundred and eighty degrees F.

71. A steaming apparatus for sanitizing a surface or object and comprising:
a reservoir for receiving water and a sanitizing agent;
a heater for heating the water and sanitizing agent within said reservoir;
a nozzle;
an actuator for enabling the heated water and sanitizing agent from said reservoir through said nozzle at the surface or object for sanitizing the surface or object.

72. The steaming apparatus of claim 71 wherein said heater is adapted to heat the water and sanitizing agent to at least approximately one hundred and eighty degrees F.
